(19) United States
(12) Patent Application Publication
(10) Pub. No.: US 2005/0200117 A1
(43) Pub. Date: Sep. 15, 2005

(54) Fracturable coated substrates for producing removable communication elements

(76) Inventor: Jesse D. Crum, Fort Scott, KS (US)

Correspondence Address: WARD KRAFT, INC., P.O. BOX 938, FORT SCOTT, KS, 66701, US

(21) Appl. No.: 10/796,881

(22) Filed: Mar. 9, 2004

(51) Int. Cl. B42D 15/00

(52) U.S. Cl. 283/62

(57) ABSTRACT

The present invention relates to business forms and other documents that are used in the conveyance of information whether business or personal to an end user or recipient. The substrate of the present invention is coated with a fracturable starch containing material which cooperates with a crush or impression pattern so as to enable the removal of an element, such as a card from the substrate when sufficient fracturing pressure is applied to the substrate or business form.

### CROSS-REFERENCES TO RELATED APPLICATIONS

None.

### FIELD OF THE INVENTION

The present invention is in the field of printed or imaged communication substrates or documents that are generally used in the conveyance of information, data, messages or the like, whether of a business or personal nature. The subject of the present application relates to the use of a fracturable material that is coated on substrates that are used in the field of information carrying or conveying, more commonly known as business forms. More particularly the article of the instant specification includes business and personal communication substrates and documents which the combination of the coating and a crush pattern create one or more removable or separable components or elements can be detached from the substrate.

### BACKGROUND OF THE INVENTION

Business forms and other business communication or information handling documents are widely known for their ability to retain, capture and convey information. Traditional business forms include medical and insurance forms, financial documents, membership lists, business, personal and accounting records and other materials used to register, retain or capture information that is suitable for use by one or more individuals or entities. Business forms and other information conveying documents continue to play an important role in our society despite the increases in electronic commerce and other automated systems designed to handle and carry information.

Manufacturers of such business forms have for some time been able to provide supplemental or auxiliary pieces either disposed on the forms or have created removable or separable parts directly from the documents. Such items include cards, labels, stickers, decals, tags and the like. Where such items are placed directly on a substrate such as by blowing or tipping on the item, the piece creates a raised area that may cause a bump or hump on the surface of the form which can lead to difficulties during the processing or imaging of the business form through an image generation means such as a printer. Alternatively, the blowing or tipping on of the additional piece can occur subsequent to the printing or imaging but the imposition of this processing step subsequent to printing or imaging may slow the egress of the form from the manufacturing facility to the intended recipient.

Other business forms may use a cut out or window into which the subsequent or supplemental piece is placed. While this will create a generally planar upper surface, the element if thicker than the substrate with which it is used or positioned with, such as for example when preparing a business form, constructed of a sheet of paper, and inserting a plastic card, the surface of the element or card that extends beyond the surface of the form will again create a bump or discontinuous surface that must be addressed during the processing of the form.

Regardless of whether the item is of an equivalent thickness to that of the substrate or has a greater or even lesser thickness than that of the substrate, the piece must still be held in position in the window or die cut area. The insertion and subsequent holding of elements in a window or die cut area has often been accomplished through the use of applying a supplemental piece of tape or patch to hold the item in position. This again, while effective in delivering the piece creates raised areas due to the imposition of the patch or tape used to hold the item in place in the substrate. In addition, the inclusion of the patch or tape increases the cost of the construction due to the supplemental material that needs to be added to the construction.

Substrates or business forms that have removable elements have also been produced through the use of directly die cutting an area of the substrate to create the removable piece or element. Die cutting is performed by creating a series of generally alternating cuts and ties so that the element can be removed by pulling the piece from the substrate by severing the ties that hold the element to the substrate. The ties hold the element in position and need to be broken in order to remove the element. Die cuts, particularly the ties, can create a removable element that has a jagged edge due to a portion of the ties remaining with the element when it is removed from the substrate. Such jagged edges take away or diminish the appearance of the removed item which can be particularly important when trying to convey a desired image or impression.

What is needed therefore is a communication document that overcomes the foregoing drawbacks and provides a substrate with one or more removable elements that can be detached cleanly from the substrate with which it is associated.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The subject of the present invention relates to substrates, such as business forms, stationery and information handling documents that are generally used and constructed to convey printed or imaged messages, data and the like regardless of whether the information is static or fixed, that is, it does not change from form to form, or if the data is personalized, that is, at least a portion of the information or data is unique to each recipient.

The business forms of the present invention may be provided in a finished state to an end user or may be provided in an intermediate state such that the business form may undergo one or more processing steps prior to being delivered to the intended recipient or end user. Such additional processing steps may include printing, imaging, folding, sealing, inserting or combinations thereof which are intended to prepare the substrate for delivery to an intended recipient.

The substrate of the present invention is coated with a unique, starch containing coating that is capable of being fractured after the application of a bending or flexing force along a crush pattern or other means suitable to initially fracture, but not release a portion of the substrate from the remainder of the substrate.

The coating of the present invention also has the unexpected and desirable attributes of creating a differential, tactile texture on the surface of the substrate in the area of the coating such that a recipient can readily identify the position and placement of the removable element such as through tactile inspection.

The removable element of the substrate is separated or detached from the substrate or business form by bending at least the portion of the substrate out of the horizontal plane so that sufficient fracture pressure is applied to the area of the coating to rupture the coating and the crush pattern thereby allowing the removable element to essentially “pop” out of the substrate and be readily grasped by the recipient.

In one exemplary embodiment of the present invention a communication substrate is described and includes a substrate that is suitable for communicating a message to an intended recipient, the substrate has first and second faces, top and bottom edges and first and second sides. A coating is applied to at least a portion of the substrate on at least one of the first and second faces. The coating of this exemplary embodiment has a starch component. A fracture area is created in the portion of the substrate so as to provide at least one removable element.

In a still further exemplary embodiment of the present invention a business form that has a removable card is provided and includes a business form that has first and second areas, front and back faces, top and bottom edges and first and second sides. A fracturable coating is provided in a portion of one of the first and second areas of the business form.

In continuing with this illustrative embodiment, a crush pattern is applied or is impressed into the portion of the business form to create at least one removable card with the crush pattern provided around a perimeter of at least one removable card.

In a yet still further exemplary embodiment of the present invention, a method of producing a communication substrate having at least one removable element, is described and includes the steps of initially providing a substrate and then coating a fracturable material on a portion of the substrate. Next, a crush pattern is applied to the portion over the coating to create at least one removable element.

In a still further exemplary embodiment of the present invention, a business form having at least one removable piece provided integrally with the business form is described and includes a substrate that is capable of receiving printing or imaging, the substrate has front and back faces, top and bottom edges and first and second sides. A starch containing coating is provided on at least a portion of the substrate. Continuing with this exemplary embodiment, a crush pattern is applied to the portion of the substrate to create a removable element that is readily identifiable. The removable element with the coating is tactilely distinguishable from uncoated portions of the substrate.

In a still further embodiment of the present invention, a business form containing a fracturable coating is described and includes a substrate having a front face and a back face with a coating applied to at least a portion of one of the front and back faces. A crush pattern is applied to the portion to create a removable element. The coating along with the crush pattern enables the removable element to be released from the portion by bending or flexing the substrate.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a front view of the coated substrate of the present invention illustrating the coating and crush patterns;

FIG. 1A shows a side view of the coated substrate of the present invention;

FIG. 2 provides an alternate embodiment of the present invention and depicts a removable element in the configuration of a card;

FIG. 2A depicts the second side of the present invention;

FIG. 3 illustrates a block diagram of an exemplary method used in carrying out the present invention;

FIG. 4 depicts a side elevation of the present invention showing the differential pattern that it tactilely distinguishable from the remainder of the substrate;

FIG. 5 shows a business form in which bending of the substrate enables the removable element to pop or break free of the substrate; and

FIG. 6 provides a schematic of the apparatus used in creating the crush or fracture pattern of the present invention.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

Surprisingly, it has been found that through the use of starches and/or starch esters, such as those derived from corn, rice, wheat, potato, tapioca, maize, sorghum and other starches and starch flours and combinations thereof, that a fracturable coating can be created on a substrate that can be used to separate removable elements from the substrate without the difficulties encountered in prior art constructions. In addition, it has been found that the coated substrate of the present invention can be used to produce a removable piece that is readily tactilely discernable from the remainder of the substrate making identification of the removable piece much more convenient to the recipient of the business communication document.

As used herein, in exemplary fashion removable elements include but are not limited to cards, labels, tags, bands, placards, signs, tickets and combinations thereof.

For the purposes of illustration the term cards, as used herein, cards includes membership cards, business cards, identification cards, loyalty program cards, participation cards and combinations thereof. Loyalty program cards include frequent shopper programs, mileage clubs and the like. Participation cards may include academic clubs and the like.

The starch based component of the present invention may be a starch or a starch ester having from 2 to 100 carbon atoms, may be selected from high or low amylose starches or combinations thereof and can typically be derived from a number of sources such as corn, rice, wheat, potato, tapioca, maize, sorghum and other starches and starch flours and combinations thereof. The starch component of the present invention can range from about 0.01% to 99.9% of the weight of the coating, with the exact percentages determined based on the needs of the end user or the particular application being sought by the manufacturer or end user.

For example, where the end user desires to have a more roughened surface the amount of starch that is present in the coating would be increased and other components would be decreased. Where the intention is to produce a smoother or glossier appearance, but one that still accomplishes the objective of the present invention, then the amount of starch would be reduced and the amount of a second component such as a varnish would be increased.

It has been found that the starch or starch ester may be added directly to the coating (mixed with the coating) without any additional treatment prior to its inclusion or application of the coating to the substrate. Of course, it is within the scope of the invention to add modifiers, enhancers and other components which may be helpful in modifying the performance of the invention.

In an exemplary embodiment illustrating use of the invention, the first component that is used in the coating for the present invention is corn starch that is available from any retail or wholesale outlet such as grocery stores (Safeway, Giant, Kroger, Dillions, Wal-Mart, Target, Sam's Club, etc.). The corn starch is used in an amount ranging from 0.01% to 99.9% by weight, with about 2 to about 50% being preferred and about 6 to about 45% being still more preferred.

The second component that makes up the present invention may be selected from a group including varnishes, overcoatings, inks, adhesives, curable coatings and combinations thereof. For the exemplary embodiment being presently described, the second component is a UV curable varnish, such as UV30LI available from Northwest Coatings Corp., Oak Creek, Wis. 53154 and is composed of various acrylate monomers and oligomers. The coating maintains a boiling point of greater than 200° C., a vapor density of greater than 1 (air=1), an evaporation rate of greater than 1 (n-Butyle Acetate=1) and a vapor pressure of less than 1 (MM HG at 25° C.).

In addition to corn starch, it should be understood that the invention may also be used with potato, rice, wheat, tapioca, maize, sorghum, starch esters and other starches and starch flours and combinations thereof. Starches may also be purchased in bulk from National Starch and Chemical Company, Chicago, Ill. In addition, starch esters may also be used having between 2 and 100 carbon atoms and can include starch acetate, starch butyrate, starch hexanote, starch benzoate, starch propionate and combinations of the foregoing. The invention may also use high amylose starch (starch having at least 45% and likely more than 65% amylose content) or low amylose starch (starch having less than 45% amylose content and preferably less than 35%). Selection of the starch or starch ester may be made in accordance with economic or production considerations, however corn starch has been selected for the illustrative embodiments of the present invention in that corn starch is widely available and may be obtained in an economically fashion.

The production of the present invention is relatively straight forward and includes the provision of a first sheet of material, such as a cellulosic based stock (20 pound bond to 100 pound card stock—any suitable bond may be used). The UV curable coating is thoroughly mixed with approximately 30% by weight corn starch. Mixing can be achieved through any suitable device such as a household blender or the like. The UV curable coating with starch added is applied to the substrate in a thickness ranging from about 0.0001 mils to 7 mils with about 0.0006 with up to about 3 mils being preferred and more particularly 0.0006 to about 0.0008 still more preferred.

The coating may be applied throughout the entire area of the substrate so as to create a completely coated sheet or a substantially coated sheet or the coating may only appear or be applied in predetermined or selected areas of the substrate or in areas such as to create removable labels, tags, cards, tickets or other elements or to illustrate certain portions of the message to be conveyed to the recipient. In addition, the coating may be applied in an area larger than the area occupied by the removable element or alternatively, the coating may be applied in a particular pattern such that once the element is removed, substantially no evidence of the coating remains on the substrate to which the coating was originally applied.

The coating may be applied through the use of fountains, meyer rods, curtains, sprays, vapor deposition, anilox rollers, gravure, reverse gravure, flexographic, printers (laser, ink jet, electrostatic, etc.) and such other means as are known and suitable for use in applying coatings.

Once the substrate has been created with the coating applied thereto, the sheet is in an intermediate condition in that the sheet or coated substrate will need to be subjected to at least one additional step prior to being ready for use. In the present example, a curing step is used to treat the UV curable material or varnish that makes up the coating of the exemplary embodiment.

The intermediate is then forwarded to a curing station where at least one if not multiple UV curing stations which contain UV bulbs that are provided for curing purposes. The curing stations may use “H” bulbs described below and/or the Gallium bulb, which is also described below.

In practicing an exemplary embodiment of the present invention, a series of UV curing bulbs, which can be positioned in a side by side, adjacent or sequential configuration, can be used. In an exemplary embodiment, a single bulb may allow a UV cure rate of approximate 50 feet per minute, while plural bulbs disposed in a side-by-side or adjacent configuration permits a higher curing rate of approximately 75 feet per minute. Obviously, other curing station configurations may be used in order to increase the possible through put rate of the equipment and processing of the substrates to be printed.

Exemplary bulbs used in the embodiment of the present invention are “H” bulbs and Gallium doped bulb suitable for use in the UV curing processes, however, it should be understood that other UV curing may be used in accordance with the present invention and the present invention is not limited hereto.

The “H” bulb is generally known as a mercury vapor bulb and is used typically for top surface curing applications. The Gallium doped bulb is used in connection with a requirement for deeper penetration such as within a slurry. The UV bulbs such as those described above along with reflectors, to focus or concentrate the energy, are available from the GEW Company, located in North Royalton, Ohio. Alternatively, a combination of both topical and penetration curing can result in a combination of curing energies sufficient to carry out the present invention. It should be understood that other curing technologies may be used in the preparation of the coating on the substrate for the present invention.

The foregoing exemplary product may then be used in the preparation of business forms with detachable or removable elements, business communication pieces, marketing or advertising collateral or any other end use for which the initial selected stock and coating are suitable. The exemplary varnish normally creates a slightly glossy finish and can be further manipulated through the addition of greater amounts of starch to create a dulled or matte finish in the final product.

With the preparation and manufacture of glossy coated stock, the starch or starch ester based coating has the additional benefit of increasing the surface affinity or frictional interaction between the sheet and another sheet, such as when placed into a stack or between the sheet and another surface such as a floor, table, countertop or the like. This improves the handling of the coated stock so that the stock may be more readily passed for subsequent processing, such as for additional printing or imaging, inserting and other post coating treatment steps.

Through the inclusion of starch in the coating of the present invention, the coating, if applied in an area that is adjacent, the end edge facilitates the grabbing by the infeed apparatus of the processing equipment, such as a printer, sorter, inserter and the like. The textural or tactile features created on the surface enable the coated substrate to be more easily acquired (gripped) by the apparatus, thus reducing slippage and timing errors created by generally coated glossy stock.

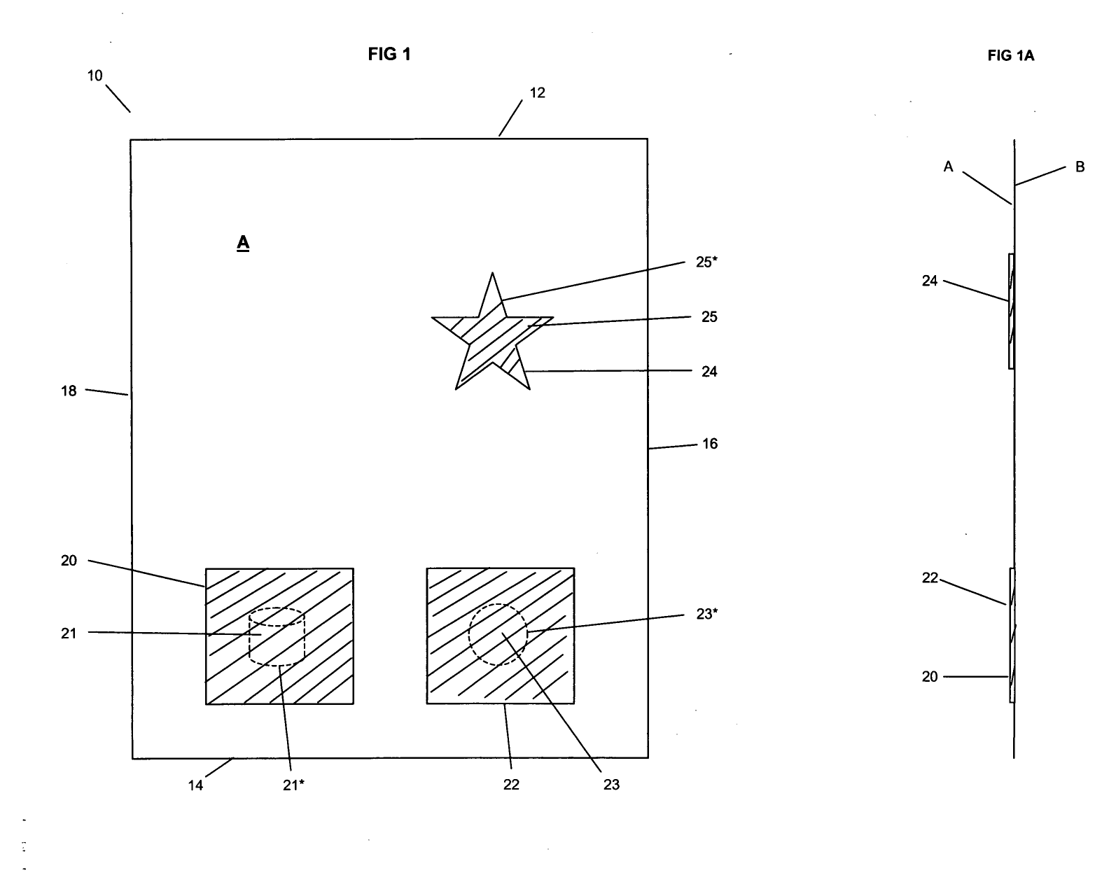

Turning now to a discussion of the FIGURES of the present application, FIG. 1 depicts a substrate 10 having a front face “A” and a back face “B” (shown in FIG. 1A), top and bottom edges 12 and 14, respectively and first and second side edges 16, and 18. As can be seen in FIG. 1, a number of coated areas 20, 22 and 24 have been provided to illustrate that one or more removable elements may be produced depending on the requirements of the customer or end user and the manufacturing capabilities of the producer of such forms.

Each of the removable elements 21, 23 and 25 is created in the coated areas 20, 22 and 24 respectively through the use of crush patterns or other impressions when used in connection with the coating will create a fracturable zone that will enable the easy separation of the elements 21, 23 and 25 from the substrate 10.

The crush patterns 21*, 23* and 25* respectively correspond to the removable elements 21, 23 and 25. As can be seen from FIG. 1, the crush patterns 21* and 23* may be entirely contained with in coated areas 20 and 22 or may be coterminous with the coated pattern as is shown by pattern 24 and crush pattern 25*. In this latter arrangement, separation of the element from the form or substrate will substantially remove all of the coating from the first face A of the form or substrate 10.

Removal of the elements from the form will obviously create a hole in the form where the element was removed from. However, where geometric, animate, inanimate or other patterns are provided the form could then be used to trace or draw patterns onto another surface.

Reference to FIG. 1A provides that the coated areas 20, 22 and 24 appear as raised areas on the face, A, to which the coating has been applied. Generally, the coating will be applied to only one of the two faces, but it should be understood that the invention is not to be limited so as to preclude the coating from appearing on both sides of the substrate 10 if either are required by an end user, or preferred in order to create greater fracturing capabilities to facilitate the separation of the removable element from the substrate.

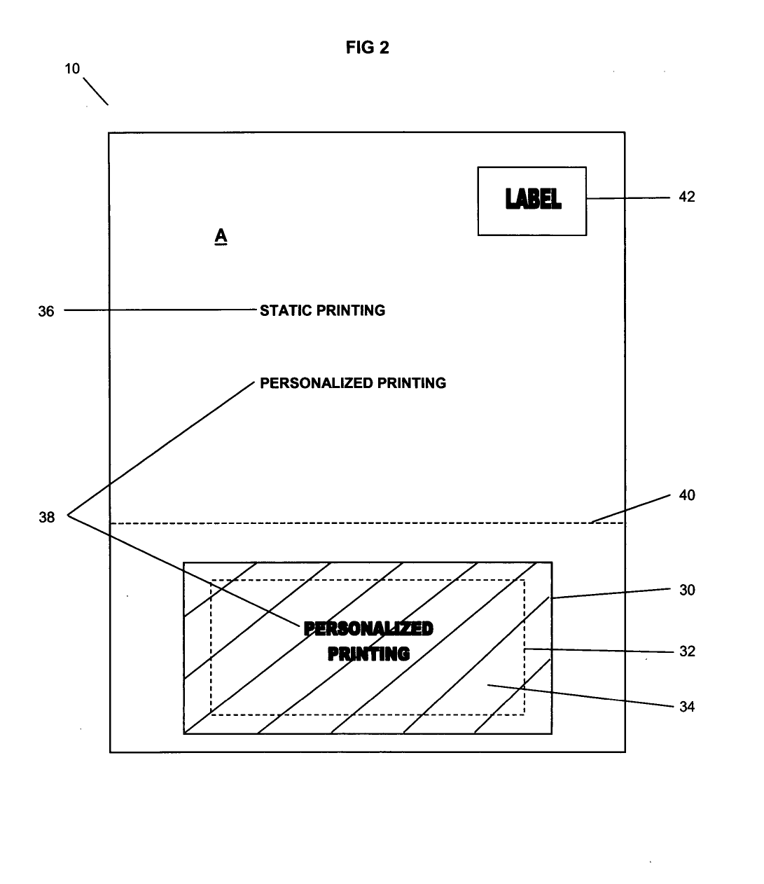

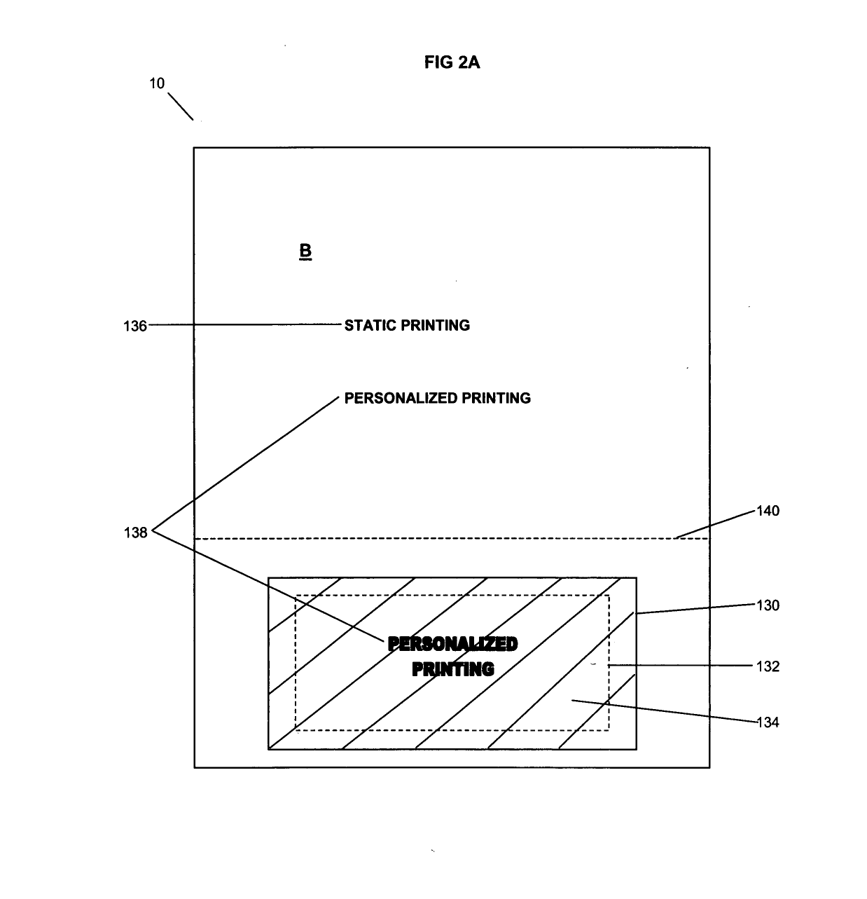

FIG. 2 presents a further embodiment of the present invention and shows a generally a removable card configuration such as one might receive in connection with an individual membership, participation in a club or other program, identification or business card or the like. The card may also be a detachable magnetic card as well, and it should be understood that a strip of magnetic material would be applied to the back of the substrate.

The substrate or business form of FIG. 2 is still depicted by reference numeral 10 and provides a first side A, however, it should be understood that the coating could be applied to the second side or back face B as shown in FIG. 1A or to both sides. The substrate 10 is coated with the exemplary coating as described above in area or portion designated by reference numeral 30. The coated portion 30 is provided with a crush or fracture zone 32 which will be described herein. It should be noted that the crush or fracture zone or pattern is generally complimentary to that of the removable element 34, here depicted as a generally quadrate card.

The business form 10 may be provided with static or fixed printing 36, printing that does not change from form to form or it may be provided with personalized printing 38, printing which is unique to the recipient or individual. It should be understood that a combination of personalized and static printing may be provided or simply one or the other. The printing or imaging of the form is purely dependent upon the needs of the end user or customer of the manufacturer. It should be understood that the printing may be provided on either side A or side B or both. The printing or imaging may be applied prior to the application of the coating or subsequent to the coating. Where printing is applied prior to the coating and in the area where the coating is to be laid down, the coating may have some level of translucence so that the imaging or printing can be visible there through.

The business form 10 of the FIG. 2 embodiment is also provided with a line of separation or demarcation 40, such as a perforation line or other line of weakness, so that the form 10 may be divided into first and second portions and the coated portion separated from record copy portion. The form 10 may also be provided with a removable label 42 which can be used to apply to the card 34 or other means to designate acceptance of an offer, participation in an event or the like.

FIG. 2A depicts side B or the second side of the substrate 10 used in the manufacture of the business form of the present invention. As with the first side A, printing may be provided that is static or fixed 136 or personalized 138 or as is illustrated both personalized and static information is provided. A line of weakness 140 separates the form into first and second parts, the form part and a portion containing a coated part. The coated area 130 is provided with a crush die zone 132 that creates a removable card 134.

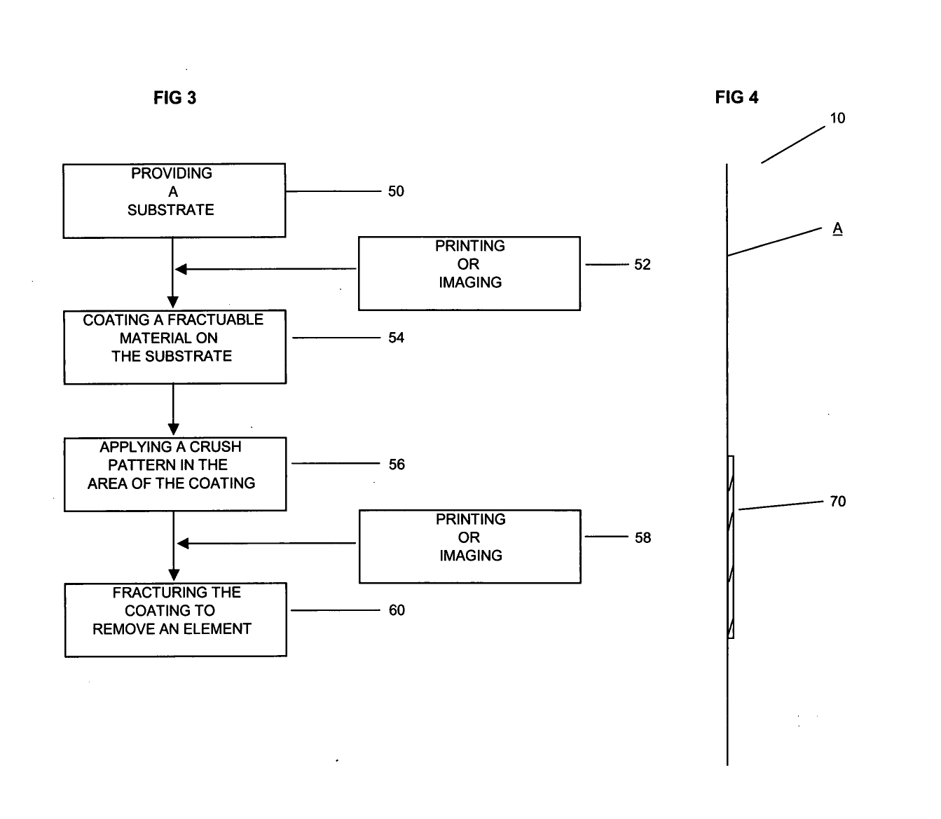

FIG. 3 presents a block diagram of an exemplary method used in the manufacture of the business form or communication substrate of the present invention. Initially, a substrate is provided at step 50. The substrate, is generally a cellulosic material selected from a stock ranging from 20 to 100 pound stock with about 80 pound tag stock being preferred. It should be understood that materials other than cellulosic material may be utilized in the present invention such as synthetic films (e.g. plastics) or metal films or foils.

The substrate may then be printed with personalized or static information as described previously at step 52 and at step 58. The printing of the substrate may occur at any time after the provision of the substrate at step 50.

The substrate is coated at step 54 with a starch containing coating, and as described in the above mentioned example, the coating contains corn starch and a UV curable varnish. In one illustrative embodiment, the components are provided with approximately 30% corn starch and 70% curable varnish. The coating is typically applied only in the area where the removable element will be created and may take the form of a generally quadrate area for ease of application. It should however be understood that the pattern can take the shape or configuration of the removable element. For example, as shown in FIG. 1, the pattern has a star shape. Any pattern or configuration is possible and the pattern may be geometric or take on the shape of animate or inanimate objects, alpha or numeric patterns and the like.

After the coating is applied a crush pattern or fracture area is created at step 56 as will be further described herein. The crush area or pattern is typically complimentary to the shape of the removable element, for example if a card is the removable element the crush pattern will have a generally quadrate shape. If a star is to be produced the crush pattern will resemble a star. It should be understood that the crush pattern is created through the use of a die and anvil as will be described herein and as such any shape can be created depending on the desires of the customer or end user.

After the coating has been applied at step 54 and then a crush pattern at step 56 the removable element can be detached from the substrate at step 60 by fracturing the coating along the crush pattern by bending or flexing the substrate such that the card or other removable element essentially “pops” out without the necessity of having to peel up a corner and then remove the card from the substrate.

Reference is now directed briefly to FIG. 4 in which the substrate or business form is depicted by reference numeral 10. The coating area 70 has been applied to a first face A and creates a raised or tactilely detectable area on the substrate 10 which enables or facilitates the easy detection of the removable element in the coated area 70. Thus, one can easily detect by feel, (such as by rubbing ones fingers or hands across the surface of the form) the raised, discontinuous or irregular area created by the coating 70 as described herein.

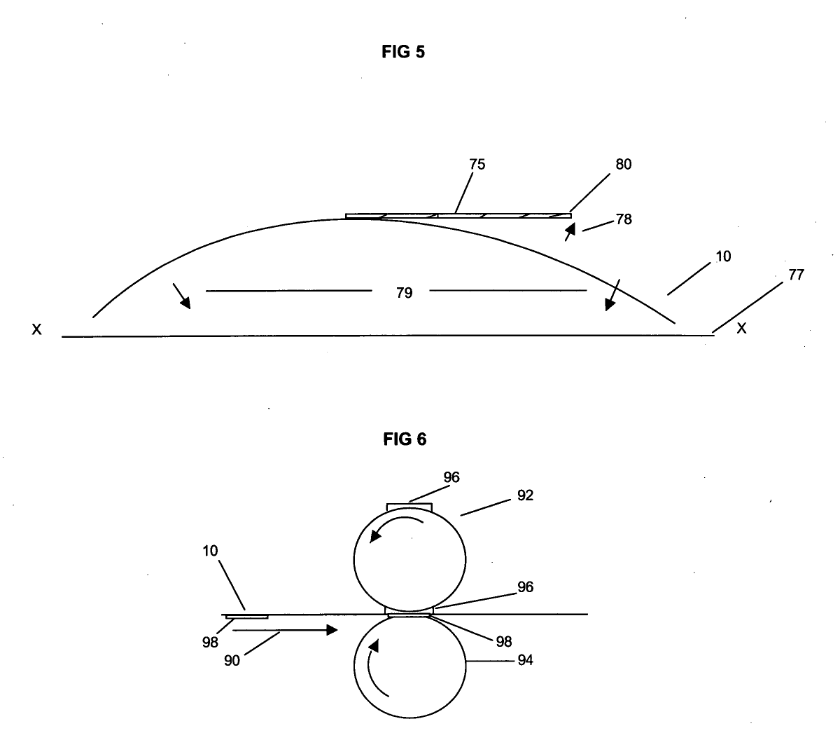

FIG. 5 is used to illustrate the removal of the removable element 80 from the substrate 10 through the use of the coating 75 and crush pattern. As can be seen from the FIGURE, the substrate 10 is bent or flexed beyond its horizontal axis 77 (from the sheet laying flat) such that the removable element 80 pops out due to the tensile forces applied by bending the substrate 10 such as through flexing, by grabbing the sides or ends of the sheet or substrate and bending or flexing the portion having the coating either upwardly or downwardly. That is, the coating 75 creates a more rigid area in that portion of the form than in the uncoated portion and thereby decreases the tensile strength of the substrate 10 in the area of the coating 75 so that upon application of sufficient fracturing force, for example bending or flexing edges or sides downwardly as shown by reference to arrows 79, the removable element 80 will release or pop up as indicated by arrow 78 along the crush pattern so as to facilitate the removal of the element 80 from the substrate 10. The recipient may then easily grasp the exposed portion of the removable element 80 and separate the remainder of the element 80 from the substrate 10.

FIG. 6 presents a schematic of the die and anvil that is used to create the crush pattern or facture area in the coating of the substrate. The substrate 10 is advanced in a machine direction 90 and encounters a rotating die cylinder and anvil station, 92 and 94 respectively. The die cylinder 92 will make an impression using a die or patterned plate 96 in the substrate 10 in the area where a coating 98 has been applied. The anvil 94 cooperates with the die 96 to provide a suitable impression surface in which to create the crush pattern. As indicated previously, the crush pattern is complementary to the size and configuration of the removable element.

Exemplary die and anvil components can be obtained from Kocher and Beck of Sahwnee, Kans., such as Kocher and Beck die number 11974 and the die and anvil combination will press a beveled edge into the substrate. Alternatively, the anvil may be provided with a flexible blanket or sleeve to aid in the creation of an impression and to prevent complete cutting of the substrate. Suitable blankets or sleeves may also be obtained from Kocher and Beck.

It will thus be seen according to the present invention a highly advantageous communication substrate having a removable element created through the use of a fracturable coating has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A communication substrate, comprising;
a substrate suitable for communicating a message to an intended recipient, said substrate having first and second faces, top and bottom edges and first and second sides;
a coating applied to at least a portion of said substrate on at least one of said first and second faces, said coating having a starch component; and
a fracture area created in said portion to provide at least one removable element.

2. A communication substrate as recited in claim 1, wherein said substrate is sized and configured to be handled by an imaging device.

3. A communication substrate as recited in claim 1, wherein said removable element is selected from a group including cards, labels, tags, bands, placards, signs, tickets and combinations thereof.

4. A communication substrate as recited in claim 1, wherein said coating creates a differential texture.

5. A communication substrate as recited in claim 1, wherein said starch component is selected from a group including corn, potato, wheat, rice, tapioca, maize, sorghum, starch esters and starch flours and combinations thereof.

6. A communication substrate as recited in claim 1, wherein said coating includes a second component selected from a group including varnishes, overcoatings, inks, adhesives, curable coatings and combinations thereof.

7. A communication substrate as recited in claim 1, wherein said starch component ranges from about 0.01% to about 99.9% by weight of said coating.

8. A communication substrate as recited in claim 1, wherein said starch component is a starch ester having from 2 to 100 carbon atoms.

9. A communication substrate as recited in claim 1, wherein said fracture area extends around a perimeter of said one removable element.

10. A communication substrate as recited in claim 1, wherein said coating is applied in a pattern complimentary to said one removable element.

11. A communication substrate as recited in claim 1, wherein said removable element is removed from the fracture area by bending at least said portion of the substrate out of a horizontal plane.

12. A business form having a removable card, comprising;
a business form having first and second areas, front and back faces, top and bottom edges and first and second sides;
a fracturable coating provided in a portion of one of said first and second areas; and
a crush pattern applied to said portion to create at least one removable card with said crush pattern provided around a perimeter of said at least one removable card.

13. A business form as recited in claim 12, wherein said coating includes a first starch component selected from a group including corn, potato, wheat, rice, tapioca, maize, sorghum, starch esters and starch flours and combinations thereof.

14. A business form as recited in claim 12, wherein said coating includes a second component selected from a group including varnishes, overcoatings, inks, adhesives, curable coatings and combinations thereof.

15. A business form as recited in claim 12, wherein said at least one removable card is selected from a group including membership cards, business cards, identification cards, loyalty program cards, participation cards and combinations thereof.

16. A business form as recited in claim 12, wherein said coating creates a differential tactile texture on said business form.

17. A business form as recited in claim 13, wherein said starch component ranges from about 0.01% to about 99.9% by weight of said coating.

18. A business form as recited in claim 12, wherein said at least one of said first and second areas are provided with printing.

19. A method of producing a communication substrate having at least one removable element, comprising the steps of;
providing a substrate;
coating a fracturable material on a portion of said substrate; and
applying a crush pattern to said portion over said coating to create at least one removable element.

20. A method as recited in claim 19, including a further step of imaging said communication substrate after the step of providing a substrate.

21. A method as recited in claim 19, including a further step of fracturing said coating to remove said at least one removable element after the step of applying the crush pattern.

22. A method as recited in claim 19, wherein said fracturable material includes a starch component selected from a group including corn, potato, wheat, rice, tapioca, maize, sorghum, starch esters and starch flours and combinations thereof.

23. A business form having at least one removable piece provided integrally with the business form comprising;
a substrate capable of receiving printing or imaging, said substrate having front and back faces, top and bottom edges and first and second sides;
a starch containing coating provided on at least a portion of said substrate;
a crush pattern applied to said portion of said substrate to create a removable element that is readily identifiable; and
wherein said removable element with said coating is tactilely distinguishable from uncoated portions of said substrate.

24. A business form as recited in claim 23, wherein said coating creates a discontinuous surface.

25. A business form containing a fracturable coating, comprising;
a substrate having a front face and a back face,
a coating applied to at least a portion of one of said front and back faces;
a crush pattern applied to said portion to create a removable element; and
wherein said coating with said crush pattern enable said removable element to be released from said portion by bending or flexing said substrate.
